(19) United States
(12) Patent Application Publication
(10) Pub. No.: US 2011/0293175 A1
(43) Pub. Date: Dec. 1, 2011

(54) IMAGE PROCESSING APPARATUS AND METHOD

(75) Inventors: Kuk Jin YOON, Gwangju (KR); Young Sun Jeon, Yongin-si (KR); Young Su Moon, Seoul (KR); Yong-Ho Shin, Gwangju (KR); Shi Hwa Lee, Seoul (KR); Min Gyu Park, Gwangju (KR)

(73) Assignees: Gwangju Institute of Science and Technology, Gwangju (KR); Samsung Electronics Co., Ltd., Suwon-si (KR)

(21) Appl. No.: 13/047,342

(22) Filed: Mar. 14, 2011

(30) Foreign Application Priority Data
Jun. 1, 2010 (KR) 10-2010-0051658

(51) Int. Cl. G06K 9/48; G06K 9/00

(52) U.S. Cl. 382/165; 382/167; 382/199

(57) ABSTRACT

Provided is an image processing apparatus. When a plurality of images acquired by photographing different directions is input, a region search unit of the image processing apparatus may search for an overlapping region within the plurality of images. An outlier removal unit may remove an outlier within the retrieved overlapping region.

### CROSS-REFERENCE TO RELATED APPLICATIONS

This application claims the priority benefit of Korean Patent Application No. 10-2010-0051658, filed on Jun. 1, 2010, in the Korean Intellectual Property Office, the disclosure of which is incorporated herein by reference.

### BACKGROUND

1. Field

Example embodiments relate to an image processing apparatus and method, and more particularly, to an apparatus and method that may correct a color tone of an image.

2. Description of the Related Art

With the development of image processing technology, technology of acquiring a plurality of images by photographing different in directions, and composing a panoramic image using the plurality of images has been configured. In particular, a digital camera provides a panoramic image composition function and thus, attracts increasing interests of users.

Due to camera setting or environmental factors, a difference of an exposure, a white balance, and the like may occur in a plurality of images acquired by photographing in different directions to compose the panoramic image. In this instance, a color tone correction may be desired.

When the color tone correction is not performed, a color tone within the composed panoramic image may look discordant and thus, a color tone correction may be desired.

In this instance, in an overlapping region between the plurality of images given or captured to generate the panoramic image, an object (hereinafter, outlier) absent in another or first image may be included in one or a second image. Due to the outlier, the color tone correction may have a poor result.

### SUMMARY

The foregoing and/or other aspects are achieved by providing an image processing apparatus, including a region search unit to search for an overlapping region within a plurality of images, and an outlier removal unit to remove an outlier within the overlapping region.

The outlier removal unit may include a similarity calculator to calculate a similarity of the overlapping region between the plurality of images, and a region divider to divide the overlapping region into a plurality of sub-regions when the similarity is less than or equal to a first threshold.

The region divider may further divide, into a plurality of sub-regions, at least one sub-region having a similarity less than the first threshold among the plurality of sub-regions generated by dividing the overlapping region.

The similarity calculator may calculate the similarity by comparing color values in the overlapping region within the plurality of images.

The region search unit may search for the overlapping region by extracting a plurality of feature points from each of the plurality of images, and by determining, as a matching pair, matching points among the extracted feature points.

The image processing apparatus may further include a color tone corrector to correct a color tone of at least one image among the plurality of images using the overlapping region having the outlier removed.

The color tone corrector may calculate a linear color transformation matrix between points constituting the matching pair by identifying the matching point among points included in the overlapping region having the outlier removed, and may correct the color tone of at least one image by applying the linear color transformation matrix to the at least one image.

The foregoing and/or other aspects are achieved by providing an image processing method, including searching for an overlapping region within a plurality of images, and removing an outlier within the overlapping region.

The removing may include calculating a similarity of the overlapping region between the plurality of images, and dividing the overlapping region into a plurality of sub-regions when the similarity is less than or equal to a first threshold.

The image processing method may further include correcting a color tone of at least one image among the plurality of images using the overlapping region having the outlier removed.

The image processing method may further include composing a panoramic image by performing the color tone correction and mixing a portion of the plurality of images.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an image processing apparatus according to example embodiments;

FIG. 2 illustrates a first image input into the image processing apparatus of FIG. 1 according to example embodiments;

FIG. 3 illustrates a second image input into the image processing apparatus of FIG. 1 according to example embodiments;

FIG. 4 illustrates a process of searching for an overlapping region between the first image of FIG. 2 and the second image of FIG. 3 in the image processing apparatus of FIG. 1 according to example embodiments;

FIG. 5 illustrates a process of generating an inlier mask by removing an outlier in the retrieved overlapping region of FIG. 4 according to example embodiments;

FIG. 6 illustrates a panoramic image composed according to example embodiments;

FIG. 7 illustrates an image processing method according to example embodiments;

FIG. 8 illustrates a process of removing an outlier from an overlapping region in the image processing method of FIG. 7 according to example embodiments; and

FIG. 9 illustrates a process of correcting a color tone in the image processing method of FIG. 7 according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

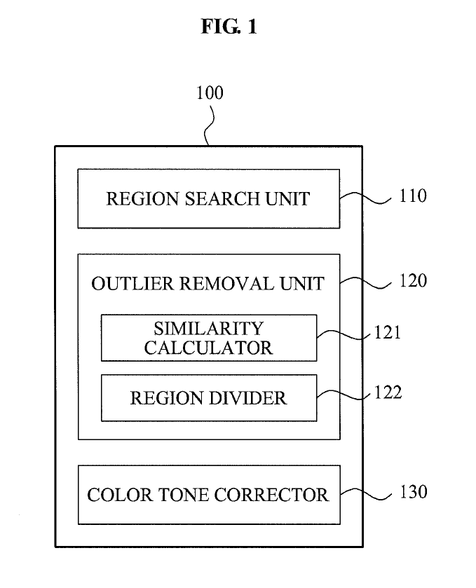

FIG. 1 illustrates an image processing apparatus 100 according to example embodiments.

A plurality of images may be input into the image processing apparatus 100.

The plurality of images may be generated by photographing in different directions from approximately the same location. However, it is only an example and thus, shapes or types of images input into and processed by the image processing apparatus 100 are not limited thereto.

When the plurality of images is input, a region search unit 110 may search for an overlapping region within the plurality of input images.

The region search unit 110 may extract feature points from each of the plurality of images, and may determine a matching pair among the extracted feature points.

The region search unit 110 may verify a portion overlapped between the plurality of images using the matching pair, and may retrieve the overlapping portion as the overlapping region.

Through the above process, the overlapping region among at least two images may be retrieved.

When the overlapping region is retrieved, an outlier removal unit 120 may remove an outlier in the overlapping region within the plurality of images.

The outlier corresponds to at least one portion of pixels of an object present in only a portion of the plurality of images. The outlier may cause an error in a color tone correction and the like using color values of the overlapping region.

Accordingly, the outlier removal unit 120 may remove the outlier in the overlapping region.

For example, when two images, that is, a first input and a second image are input, a similarity calculator 121 may calculate a similarity between an overlapping region within the first image and an overlapping region within the second image. In this example, the similarity may be calculated using a color value distribution.

When the calculated similarity is less than or equal to a first threshold, a region divider 122 may divide the overlapping region into a plurality of sub-regions, for example, two sub-regions. Here, the sub-region may also be referred to as a “child region”.

With respect to each of the sub-regions, the similarity calculator 121 may calculate a similarity between a corresponding portion within the first image and a corresponding portion within the second image, and may compare the similarity with the first threshold.

When a sub-region having the similarity less than or equal to the first threshold is included in the plurality of sub-regions, the region divider 122 may divide the sub-region into at least two sub-regions.

By recursively performing the above process a predetermined number of times, only a portion having the similarity greater than the first threshold may remain without being further divided. Accordingly, an inlier mask including not-further divided portions may remain.

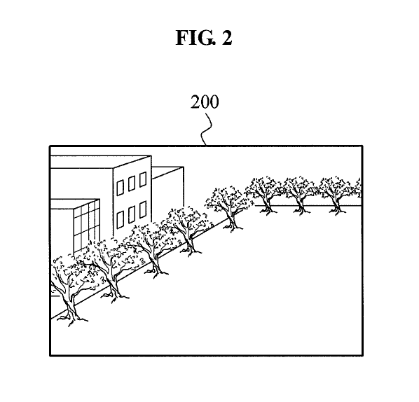

An operation of the outlier removal unit 120 will be further described with reference to FIG. 2 through FIG. 5.

When the outlier portion is removed in the overlapping region, a color tone corrector 130 may perform a color tone correction with respect to at least one portion of the plurality of images, based on color values of a remaining overlapping region.

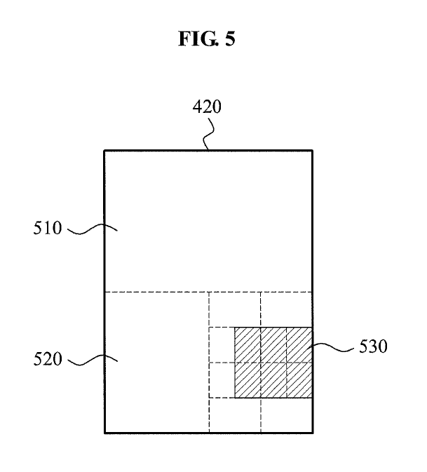

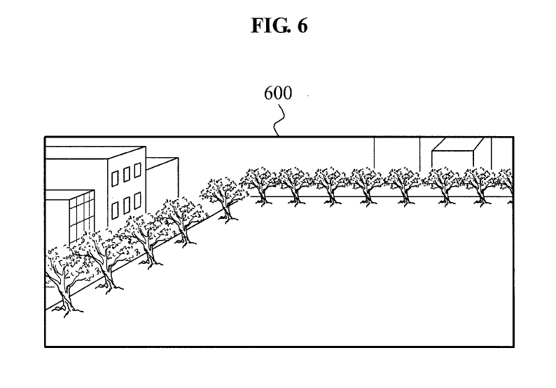

The color tone correction will be further described with reference to FIG. 5 and FIG. 6.

FIG. 2 illustrates a first image input 200 into the image processing apparatus 100 of FIG. 1 according to example embodiments.

The first image 200 corresponds to a predetermined size of a still cut acquired by photographing in a first direction. The still cut has a constrained viewing angle and thus, may display only a portion of a direction of the photographed scene.

Depending on embodiments, an image with respect to a relatively wide viewing angle may need to be included in one piece of or one photo. However, even though a lens is replaced with an optical type, the viewing angle may be still constrained.

Accordingly, a panoramic photo may be composed through processing using at least two photos acquired with respect to different directions. A composition direction of the panoramic photo is referred to as blending.

With respect to a plurality of input images acquired by photographing in different directions, an image processing method for composition of the panoramic photo may be performed in a system or an apparatus, for example, a computer and the like, excluding a camera. However, the image processing method may be configured using a function included in a digital camera.

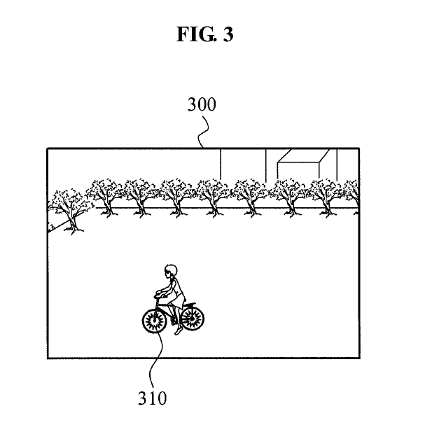

An image acquired by photographing a in direction different from the first image 200 at the same position or location is shown in FIG. 3.

FIG. 3 illustrates a second image 300 input into the image processing apparatus 100 of FIG. 1 according to example embodiments.

For more natural panoramic image composition, at least one portion of an overlapping region between at least two images acquired by photographing different directions may need to be included in the at least two images.

A portion of a left side of the second image 300 is overlapped with a portion of a right side of the first image 200.

However, the first image 200 and the second image 300 may not be simultaneously photographed. Accordingly, an outlier, for example, a moving object may be included in only one image in the overlapping region.

In FIG. 3, a girl riding a bicycle corresponding to a moving object 310 is included in the second image 300 as an outlier.

In a composition process of the panoramic image, a total color tone such as exposure, white balance, and the like may be different between the first image 200 and the second image 300. Accordingly, a color tone correction for correcting the difference may be used. The outlier may cause an inaccurate correction in the color tone correction.

Accordingly, the image processing apparatus 100 may decrease an inaccuracy of color tone correction occurring due to the outlier.

Hereinafter, a process of searching for the overlapping region between the first image 200 and the second image 300, and correcting a total image color tone using a color of an inlier mask portion remaining after excluding the outlier in the retrieved overlapping region will be further described.

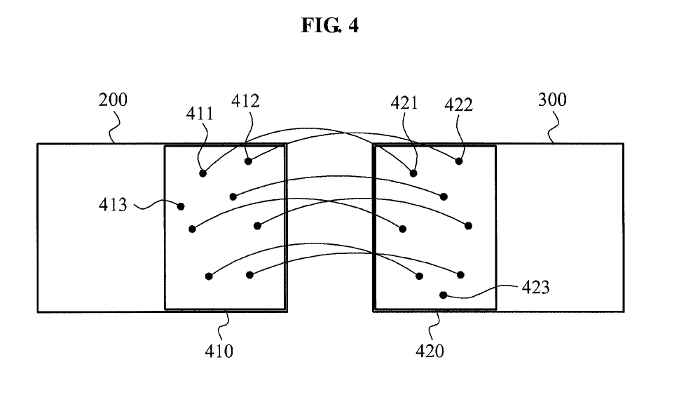

FIG. 4 illustrates a process of searching for an overlapping region between the first image 200 of FIG. 2 and the second image 300 of FIG. 3 in the image processing apparatus 100 of FIG. 1 according to example embodiments.

Using a feature point extraction algorithm, the region search unit 110 may identify matching pairs between feature points extracted from the first image 200 and feature points extracted from the second image 300. For example, the region search unit 110 may identify matching pairs (411, 421) and (412, 422) between feature points 411, 412, and 413 of the first image 200 and feature points 421, 422, and 423 of the second image of the second image 300.

In this example, non-matching feature points, for example, the feature points 413 and 423 may be excluded. According to example embodiments, a random sample consensus (RANSAC) algorithm and the like may be employed.

Through the above process, the region search unit 110 may search for an overlapping region 410 within the first image 200 and an overlapping region 420 within the second image 300.

As described above with reference to FIG. 2 and FIG. 3, the overlapping region 410 of the first image 200 and the overlapping region 420 of the second image 300 may not accurately match each other due to a moving object and the like, and an outlier may be included.

In this example, the outlier removal unit 120 may remove the outlier in the overlapping region 410 and/or the overlapping region 420, and the color tone corrector 130 may perform a color tone correction using a remaining region having the outlier removed. The remaining region may also be referred to as an inlier mask.

FIG. 5 illustrates a process of generating an inlier mask by removing an outlier in the retrieved overlapping region 420 of FIG. 4 according to example embodiments.

The similarity calculator 121 may calculate a similarity between the overlapping region 410 and the overlapping region 420.

A color distribution may be used for the similarity calculation. For example, the similarity may be calculated using a variety of schemes such as a color distribution and a histogram distribution, and the like within a map of a color system.

For example, the similarity calculator 121 may calculate the similarity between the total overlapping region 420 and the overlapping region 410 according to Equation 1:

$$Similarity = \frac{{\sum }_{Cr} {\sum }_{Cb} min ( h ( Cr , Cb ) , g ( Cr , Cb ) )}{{\sum }_{Cr} {\sum }_{Cb} h ( Cr , Cb ) or {\sum }_{Cr} {\sum }_{Cb} g ( Cr , Cb )} \qquad [ Equation 1 ]$$

In Equation 1, h(Cr, Cb) and g(Cr, Cb) correspond to color values of the overlapping region 410 of the first image 200 and the overlapping region 420 of the second image 300 according to YCbCr color system.

In Equation 1, one of a summation of h(Cr, Cb) and a summation of g(Cr, Cb) may be selected as a denominator, and a smaller value between the summations may be selected as a numerator.

However, the above equation is only an example to be applicable for an operation of the similarity calculator 121 and thus, other calculation algorithms or equations may be employed.

When the similarity calculator 121 calculates the similarity between the overlapping regions 410 and 420, the region divider 122 may compare the calculated similarity with a predetermined first threshold. The first threshold may be a value that may be arbitrarily set depending on embodiments, for example, a setting value 95%.

When the calculated similarity is less than or equal to the first threshold, the region divider 122 may divide the overlapping region into a plurality of sub-regions. For example, the region divider 122 may divide the overlapping region 420 into two sub-regions 510 and 520.

With respect to each of the sub-regions 510 and 520, the similarity calculator 121 may calculate a similarity with respect to the same portion within the overlapping region 410 of the first image 200.

When a similarity between the sub-region 510 and the same portion of the overlapping region 410 of the first image 200 exceeds the first threshold, the region divider 122 may not perform region division with respect to the sub-region 510 and may treat the sub-region 510 as an inlier.

When the similarity calculated with respect to the sub-region 520 is less than or equal to the first threshold, a recursive region division of further dividing a corresponding region into a plurality of sub-regions may be performed with respect to the sub-region 520.

The above repeating recursive region division and similarity calculation process may be suspended through a predetermined number of iterations. In this example, the similarity may be calculated to exceed the first threshold whereby a not-further divided portion may be determined as an inlier and a remaining portion may be removed as an outlier.

When the calculated similarity is less than or equal to a second threshold, for example, 5%, region division may not be performed with respect to a corresponding region and the corresponding region may be determined as an outlier and be removed.

The example embodiments are only examples and thus, other various example embodiments may be applicable.

Through the above process, a remaining inlier mask where an outlier portion 530 is removed may be determined.

The color tone corrector 130 may analyze a color value difference between the first image 200 and the second image 300 only with respect to color values of the portion corresponding to the inlier mask.

The analysis is to obtain a linear color transformation matrix between matching pairs of feature points. The matching pair may also be referred to as matching points.

For example, when the linear color transformation matrix calculated by the color tone corrector 130 is associated with a color transformation of transforming matching points included in the second point 300 to matching points included in the first image 200, the color tone corrector 130 may apply the linear color transformation matrix to all the pixels of the second image 300.

The total color tone of the second image 300 may be corrected to be similar to the first image 200.

Even though a criterion of the color tone correction applies to the inlier mask alike, the color tone correction may be performed according to other example embodiments. For example, a conventional histogram matching scheme and the like may be applied.

When the color tone correction is performed, the image processing apparatus 100 may generate a panoramic image by mixing the first image 200 and the second image 300. In the above process, an image of the overlapping region 410 of the first image 200 or an image of the overlapping region 420 of the second image 300 may be used with respect to the overlapping region. A difference between the image of the overlapping region 410 and the image of the overlapping region 420 may depend on whether the moving object 310 is included in the result.

FIG. 6 illustrates a panoramic image 600 composed according to example embodiments.

In FIG. 6, the image processing apparatus 100 may perform blending using the overlapping region 410 of the first image 200.

A variety of schemes may be employed for composing the panoramic image 600.

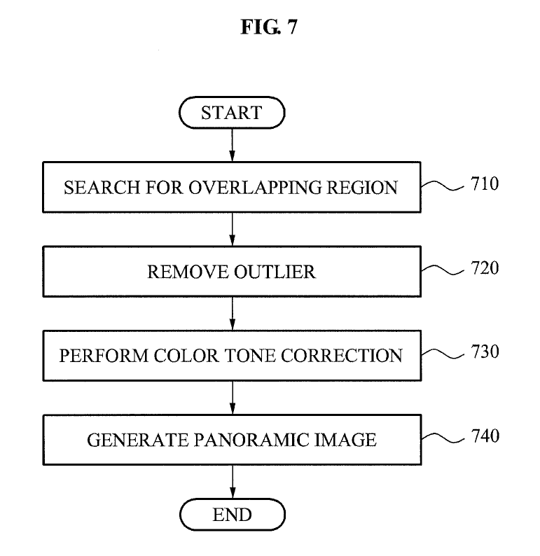

FIG. 7 illustrates an image processing method according to example embodiments.

In operation 710, the region search unit 110 of the image processing apparatus 100 may search for an overlapping region within a plurality of input images.

The overlapping region searching process may be performed according to various example embodiments. For example, the region search unit 110 may extract feature points in each of the input images, and may determine matching pairs among the extracted feature points, and may retrieve, as the overlapping region, a portion overlapped between the plurality of images.

Descriptions made above with reference to FIG. 1 through FIG. 4 may be applicable to the overlapping region search.

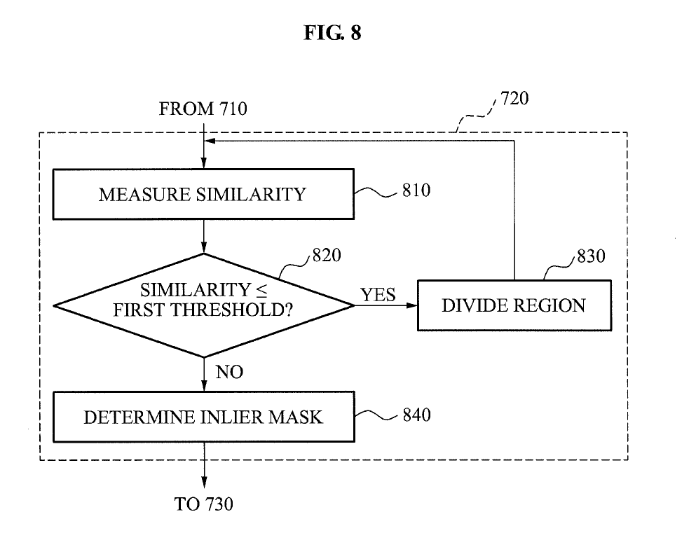

In operation 720, the outlier removal unit 120 may make an inlier mask by removing the outlier. The outlier removing process will be further described with reference to FIG. 8.

When the outlier is removed and only the inlier mask remains in the overlapping region, the color tone corrector 130 may perform a color tone correction using colors of the inlier mask.

In operation 740, the image processing apparatus 100 may compose the panoramic image by mixing the plurality of images.

FIG. 8 illustrates a process of removing an outlier in an overlapping region in the image processing method of FIG. 7 according to example embodiments.

In operation 810, the similarity calculator 121 may calculate a similarity with respect to a total overlapping region.

In operation 820, the region divider 122 may determine whether the calculated similarity is less than or equal to a first threshold. When the calculated similarity is less than or equal to the first threshold, the region divider 122 may perform a region division in operation 830. The region division process is described above with reference to FIG. 5.

The above recursively repeated process is also described above.

In operation 840, the outlier removal unit 120 may determine the inlier mask and a process following operation 730 may be performed.

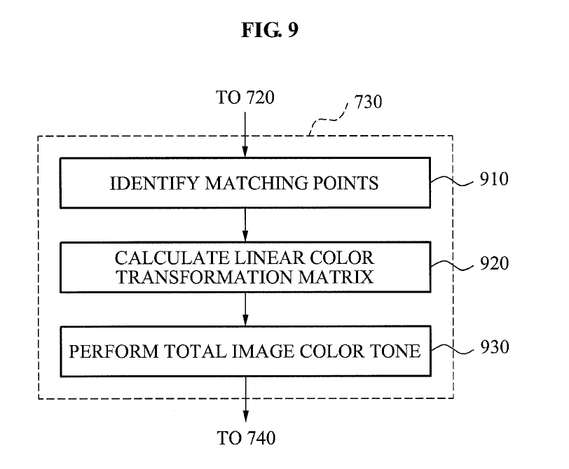

FIG. 9 illustrates a process of correcting a color tone in the image processing method of FIG. 7 according to example embodiments.

In operation 910, the color tone corrector 130 may identify matching points, that is, matching pairs of feature points within the inlier mask.

In operation 920, the color tone corrector 130 may calculate a linear color transformation matrix. In operation 930, the color tone corrector 130 may perform the color tone correction by applying the calculated linear color transform to the total image.

The above process is described above with reference to FIG. 5 and FIG. 6.

The image processing method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image processing apparatus, comprising:
a region search unit to search for an overlapping region within a plurality of images; and
an outlier removal unit to remove an outlier within the overlapping region.

2. The image processing apparatus of claim 1, wherein the outlier removal unit comprises:
a similarity calculator to calculate a similarity of the overlapping region between the plurality of images; and
a region divider to divide the overlapping region into a plurality of sub-regions when the similarity is less than or equal to a first threshold.

3. The image processing apparatus of claim 2, wherein the region divider further divides, into a plurality of sub-regions, at least one sub-region having a similarity less than the first threshold among the plurality of sub-regions generated by dividing the overlapping region.

4. The image processing apparatus of claim 2, wherein the similarity calculator calculates the similarity by comparing color values in the overlapping region within the plurality of images.

5. The image processing apparatus of claim 2, wherein the similarity calculator calculates the similarity by comparing any one of color distribution and histogram distribution in a map of a color system.

6. The image processing apparatus of claim 1, wherein the region search unit searches for the overlapping region by extracting a plurality of feature points from each of the plurality of images, and by determining, as a matching pair, matching points among the extracted feature points.

7. The image processing apparatus of claim 1, further comprising:
a color tone corrector to correct a color tone of at least one image among the plurality of images using the overlapping region having the outlier removed.

8. The image processing apparatus of claim 7, wherein the color tone corrector calculates a linear color transformation matrix between points constituting the matching pair by identifying the matching point among points included in the overlapping region having the outlier removed, and corrects the color tone of at least one image by applying the linear color transformation matrix to the at least one image.

9. An image processing method, comprising:
searching for an overlapping region within a plurality of images; and
removing an outlier within the overlapping region.

10. The image processing method of claim 9, wherein the removing comprises:
calculating a similarity of the overlapping region between the plurality of images; and
dividing the overlapping region into a plurality of sub-regions when the similarity is less than or equal to a first threshold.

11. The image processing method of claim 10, wherein the dividing of the overlapping region comprises further dividing, into a plurality of sub-regions, at least one sub-region having a similarity less than the first threshold among the plurality of sub-regions generated by dividing the overlapping region.

12. The image processing method of claim 10, wherein the calculating similarity by comparing any one of color distribution and histogram distribution in a map of a color system.

13. The image processing method of claim 10, wherein the calculating comprises calculating the similarity by comparing color values in the overlapping region within the plurality of images.

14. The image processing method of claim 9, wherein the searching comprises searching for the overlapping region by extracting a plurality of feature points from each of the plurality of images, and by determining, as a matching pair, matching points among the extracted feature points.

15. The image processing method of claim 9, further comprising:
correcting a color tone of at least one image among the plurality of images using the overlapping region having the outlier removed.

16. The image processing method of claim 15, wherein the correcting comprises calculating a linear color transformation matrix between points constituting the matching pair by identifying the matching point among points included in the overlapping region having the outlier removed, and correcting the color tone of at least one image by applying the linear color transformation matrix to the at least one image.

17. The image processing method of claim 15, further comprising:
composing a panoramic image by performing the color tone correction and mixing a portion of the plurality of images.

18. A non-transitory computer-readable medium comprising a program for instructing a computer to perform the method of claim 9.
